(19) United States
(12) Patent Application Publication
(10) Pub. No.: US 2012/0287122 A1
(43) Pub. Date: Nov. 15, 2012

(54) VIRTUAL APPAREL FITTING SYSTEM AND METHOD

(75) Inventors: RAJESH PAUL NADAR, BANGALORE (IN); RAVI BANGALORE RAMARAO, BANGALORE (IN); DEEPESH JAYAPRAKASH, BANGALORE (IN); SURESH NARASIMHA, BANGALORE (IN)

(73) Assignee: TELIBRAHMA CONVERGENT COMMUNICATIONS PVT. LTD., BANGALORE (IN)

(21) Appl. No.: 13/466,152

(22) Filed: May 8, 2012

(30) Foreign Application Priority Data
May 9, 2011 (IN) 1595/CHE/2011

(51) Int. Cl. G06T 17/00; G09G 5/377

(52) U.S. Cl. 345/419; 345/632

(57) ABSTRACT

The various embodiments herein provide a virtual apparel fitting system and a method for displaying the plurality of apparels virtually on the user. The virtual apparel fitting system includes an image capturing device and a digital screen. The image capturing device captures an image of a user and the digital screen recognizes one or more physical statistics of the user from the captured image. Further the user selects a plurality of apparels from the apparel library and the plurality of apparels are displayed virtually on the captured image of the user in the digital screen with a prediction on the accurate size and fit of the plurality of apparels on the user.

### CROSS-REFERENCE TO RELATED APPLICATION

The present application claims the priority of the Indian Provisional Patent of Application No. 1595/CHE/2011 filed on 9 May, 2011 having the title “Virtual Apparel Fitting System”, and the contents of which are incorporated by reference herein.

### BACKGROUND

1. Technical field

The embodiments herein generally relate to image processing systems and methods and particularly relate to implementing a real time virtual apparel fitting system. The embodiments herein more particularly relates to providing accurate size prediction and analysis of fit of apparels on a user and displaying a realistic visual representation of the apparels fit on the user virtually.

2. Description of the Related Art

The current practices in the apparel selection segment necessitates a user to manually try out a plurality of apparels of their preferences in a trial room and determine the best fitting apparel among the plurality of apparels. According to the existing techniques, the users proceed through a trial-and-error process of trying various apparels to assess the fitting and to make out how each apparel look on the user. The manual process involved in trying out the plurality of apparels by the user is time consuming, reduces the quality of the apparels and also leads to hygienic issues due to repetitive wearing of the apparels by various users. Further, the rearrangement of the apparels after trying out by various users is a tedious process and also consumes considerable time of a salesperson displaying the apparels in the stores.

Different inventions are known in relation to virtual fitting rooms to resolve the aforementioned problems. The existing virtual apparel fitting systems use three-dimensional representations of the user and the apparels by means of corresponding scanning or by means of virtual model libraries to determine the statistics of various users' body and to see how different apparels would fit on them.

Although, the aforementioned methodology provides advancement with regard to the conventional methods, the complexity involved in obtaining the 3D representations of the users and all the garments in real time causes difficult implementation of such methods and systems. Also such methodologies require systems with high processing capabilities and storage capacities which in turn incur a huge cost. Further the existing techniques use the previously taken image of the user for creating the 3D representation of the user which fails to provide the results in real time. Furthermore, the existing apparel fitting system requires user interaction and is mostly time consuming.

Hence there is a need to provide a virtual apparel fitting system and method to display the appearance of preferred apparels on a user in real time. Further there is a need for a virtual apparel fitting system and method which determines the body measurements of the user for accurate fitting of the apparel on the user. Moreover, there is also a need for real time virtual apparel fitting system and method that requires minimal or no user interaction for accurate fitting of the apparel on the user.

The above mentioned shortcomings, disadvantages and problems are addressed herein and which will be understood by reading and studying the following specification.

### OBJECTS OF THE EMBODIMENTS

The primary object of the embodiments herein is to provide a. virtual apparel fitting system and a method which renders users with a high realistic appearance of an apparel of interest in real time.

Another object of the embodiments herein is to provide a virtual apparel system and a method for capturing 2-Dimensional image of a user in a controlled environment for determining the body measurements of the user.

Yet another object of the embodiments herein is to provide a virtual apparel fitting system and a method to enables a user to select one or more apparels to be tried on out of a virtual apparel library.

Yet another object of the embodiments herein is to provide a virtual apparel fitting system and a method for obtaining the body co-ordinate measurements of a user.

Yet another object of the embodiments herein is to provide a virtual apparel fitting system and a method to showcase the selected apparels on the user without actually trying them.

Yet another object of the embodiments herein is to provide a virtual apparel fitting system and a method which consumes a less time for determining an accurate size and fitting of apparel on the user.

Yet another object of the embodiments herein is to provide a virtual apparel fitting system and a method which requires minimal or no user interaction to display the apparels on the user in a virtual mirror.

Yet another object of the embodiments herein is to provide a virtual apparel fitting system and method to enable a user to input a gender information with the help of the hand gestures.

Yet another object of the embodiments herein is to provide the real time virtual apparel fitting system and a method which does not require any marker to determine the, body points of the user.

Yet another object of the embodiments herein is to provide a virtual apparel fitting system and a method which requires a less expensive mechanism to capture an image/video of a user for real time apparel fitting.

These and other objects and advantages of the present invention will become readily apparent from the following detailed description taken in conjunction with the accompanying drawings.

### SUMMARY

The embodiments herein provide a virtual apparel fitting system for displaying the plurality of apparels virtually on the user. The virtual apparel fitting system includes an image capturing device and a digital screen. The image capturing device captures an image of a user and the digital screen recognizes one or more physical statistics of the user. Further the user selects a plurality of apparels from the apparel library and the plurality of apparels are displayed virtually on the captured image of the user in the digital screen for predicting an accurate size and analyzing the fit of the plurality of apparels on the user.

According to an embodiment herein, the digital screen includes an image processing unit and a display unit.

According to an embodiment herein, the image processing unit includes a segmentation module and a 3D rendering engine.

According to an embodiment herein, the segmentation module divides the captured image into a plurality of segments.

According to an embodiment herein, the image captured is divided into the plurality of segments for detecting control points corresponding to the physical statistics of the user.

According to an embodiment herein, the segmentation module identifies a foreground region from the background of the image captured of the user.

According to an embodiment herein, the 3D rendering engine optimizes the control points detected for adjustment of the apparel on the user to provide an accurate fit.

According to an embodiment herein, the 3D rendering engine calculates a pose and an orientation of the user based on the control points optimized from the image of the user.

According to an embodiment herein, the position and orientation of the user optimized from the control points are computed using a pose estimation algorithm.

According to an embodiment herein, the digital screen is fed with the gender of the user based on the hand gesture input from the user.

According to an embodiment herein, the display unit displays a 3D representation of the plurality of apparels to the user based on the gender information input by the user using hand gestures.

According to an embodiment herein, the image processing unit obtains the body co-ordinate measurements from the captured image of the user.

According to an embodiment herein, the recognized one or more physical statistics are reference points representing the body parts of the user.

The embodiments herein provide a method for performing a virtual apparel fitting. The method includes initiating a virtual apparel fitting system, capturing an image of the user using the virtual apparel fitting system, selection of the gender of the user by hand gesture as input, segmenting the image captured into one or more segments, obtaining control points from the segmented image, calculating a pose and an orientation of the user based on the control points obtained, optimizing the control points to adjust a plurality of apparels virtually on the captured image of the user, rendering the plurality of apparels virtually on the captured image of the user and displaying a 3D representation of the plurality of apparels to the user with an accurate fit.

According to an embodiment herein, the plurality of apparels is selected from a virtual apparel library integrated with the digital screen.

According to an embodiment herein, the image of the body is segmented to determine a face region from the captured image of the user.

According to an embodiment herein, the control points are obtained based on the one or more physical statistics recognized from the captured image of the user.

According to an embodiment herein, the control points are optimized to eliminate a false detection of the control points from the captured image.

According to an embodiment herein, the control points are optimized to predict an accurate size and analyze the fit of the plurality of apparels on the image captured.

The embodiments herein provide a virtual apparel fitting system and a virtual apparel fitting feature which recognizes the physical statistics of an individual and enables the user to select the apparels of his/her preference virtually and displaying the appearance of the selected apparel on the user in a virtual mirror in real time. The system includes a digital screen and an image capturing device associated with the digital screen in a controlled environment. The system also includes an image processing unit integrated with the digital screen for image analysis of the user in real time.

According to an embodiment herein, the user stands in front of the digital screen and the image of the user is captured by the image capturing device. The digital screen helps in the selection of the gender of the user by using a hand gesture as an input. The digital screen includes a display unit which displays a 3D representation of a plurality of apparels to the user based on a gender recognition. The system recognizes a plurality of physical statistics of the user for predicting the accurate size and analysis of fit of the apparel on the body of the user. The physical statistics includes a series of control points which are the reference points representing the body parts including shoulder, chest, and the like. The system further displays the user with the 3D model of the apparels fitted on the user on the digital screen without the user actually wearing them.

According to an embodiment herein, the image processing unit includes a segmentation module which performs image processing by dividing the input captured image into various segments. The segmentation module initially constructs the background information from the image/video captured by the image capturing device. An initial foreground region is constructed by a background difference using multiple thresholds. The shadow regions are eliminated using the color components and each object is labeled with its own identification number. Further, the silhouette extraction techniques are used to smoothen the boundaries of the foreground region and region growing technique is employed to recover the required characteristics to generate the final foreground region. The foreground region thus identified is segmented from the background. Further the results are adjusted by concentrating on the face region and the body of the user is segmented out from the background.

According to an embodiment herein, the image processing unit further includes a 3D rendering engine which determines the control points of the segmented out image of the body of the user. The control points corresponding to face region, shoulder region and chest region are detected by an image analysis. Further the control points are refined to avoid any false detections contributing to the result.

According to an embodiment herein, the control points are determined by calculating the distance between the vertical axis and the boundary point of the body and considering the maximum distances on both sides.

According to an embodiment herein, the image processing unit further calculates a pose and an orientation of the user using the control points by tracking and estimating the pose. The 3D rendering engine then performs a fitting and renders the dress model on the user based on the estimated pose.

According to an embodiment herein, the position and orientation of the user from the control points tracked are computed using a pose estimation algorithm.

According to an embodiment herein, the virtual apparel fitting performs the fitting and rendering of the 3D model of the apparel based on the estimated pose of the user.

According to an embodiment herein, the digital screen is an electronic device. The electronic device includes but is not limited to a touch screen device, a PDA, and a mobile device.

According to an embodiment herein, the image capturing device is a 2-dimensional camera.

These and other objects and advantages of the present invention will become readily apparent from the following detailed description taken in conjunction with the accompanying drawings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a real-time virtual apparel fitting system, according to an embodiment herein.

FIG. 2 illustrates a flow chart explaining a method of providing a virtual apparel fitting, according to an embodiment herein.

FIG. 3 illustrates a flowchart explaining a method for segmenting a user image from the background, according to an embodiment herein.

FIG. 4 illustrates a flowchart explaining a method for detecting the body point coordinates for accurate fitting of the apparel, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a virtual apparel fitting system for displaying the plurality of apparels virtually on the user. The virtual apparel fitting system includes an image capturing device and a digital screen. The image capturing device captures an image of a user and the digital screen recognizes one or more physical statistics of the user. Further the user selects a plurality of apparels from the apparel library and the plurality of apparels are displayed virtually on the image captured of the user in the digital screen predicting an accurate size and analyzing of fit of the plurality of apparels.

The digital screen includes an image processing unit and a display unit.

The image processing unit includes a segmentation module and a 3D rendering engine.

The segmentation module divides the captured image into a plurality of segments.

The captured image is divided into the plurality of segments for detecting control points corresponding to the physical statistics of the user.

The segmentation module identifies a foreground region from the background of the image captured of the user.

The 3D rendering engine optimizes the control points detected for adjustment of the apparel on the user to provide an accurate fit and the 3D rendering engine calculates a pose and an orientation of the user based on the control points optimized from the image of the user.

The position and the orientation of the user optimized from the control points are computed using a pose estimation algorithm.

The digital screen helps in the selection of the gender of the user by using a hand gesture as an input.

The display unit displays a 3D representation of the plurality of apparels to the user based on the input gender information by the user using hand gestures. The image processing unit obtains the body co-ordinate measurements from the captured image of the user.

The one or more physical statistics recognized are reference points representing the body parts of the user.

The embodiments herein provide a method for performing a virtual apparel fitting. The method includes initiating a virtual apparel fining system, capturing an image of the user using the virtual apparel fitting system, selecting the gender of the user by using the hand gesture as input, segmenting the captured image into one or more segments, obtaining the control points from the segmented image, calculating a pose and an orientation of the user based on the control points obtained, optimizing the control points to adjust a plurality of apparels virtually on the captured image of the user, rendering the plurality of apparels virtually on the captured image of the user and displaying a 3D representation of the plurality of apparels to the user with accurate fit.

The plurality of apparels is selected from a virtual apparel library integrated with the digital screen.

The image of the body is segmented to determine a face region from the captured of the user.

The control points are obtained based on the one or more physical statistics recognized from the captured image of the user and the control points are optimized to eliminate a false detection of the control points from the captured image.

The control points are further optimized to predict an accurate size and analyze the fit of the plurality of apparels on the captured image.

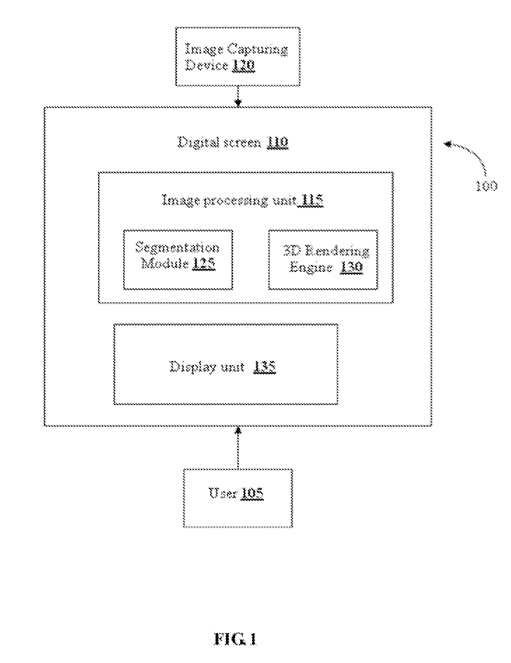

FIG. 1 illustrates a block diagram of a real-time virtual apparel fitting system, according to an embodiment herein. With respect to FIG. 1, the real time virtual apparel fitting system includes a digital screen 110 having a display unit 135 and an image processing unit 115 integrated with the digital screen 110.

The system further includes an image capturing device 120 arranged in conjunction with the digital screen 110 in a controlled environment. The image capturing device 120 according to the embodiments herein is at least one of a video recorder and camera, preferably a 2-dimensional digital camera. When the user 105 stands in front of a digital screen 110, the image capturing device 120 with a face detection technique captures the image of the user 105.

The image processing unit 115 includes a segmentation module 125 for segmenting the captured image of the user 105 into a plurality of segments for detecting the body control points corresponding to the physical statistics of the user 105. The image processing unit 115 also includes a 3D rendering engine 130 to optimize the control points for adjustment of the apparel to provide an accurate fit on the user 105 in accordance with the physical statistics calculated. The digital screen 110 also includes a display unit 135 for displaying the apparel fitted correctly on the user 105 based on the detected control points.

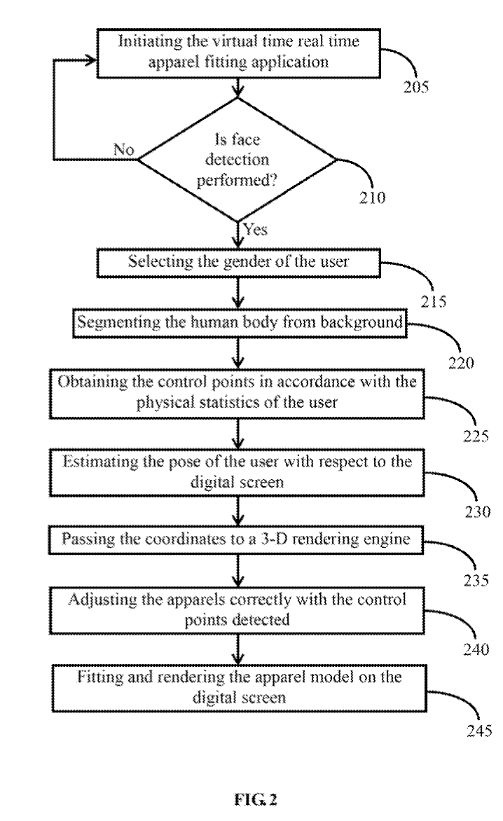

FIG. 2 illustrates a flow chart explaining a method of providing a virtual apparel fitting, according to an embodiment herein. With respect to FIG. 2, the real time virtual apparel fitting application is initialized when a user stands in front of a digital screen (205). The image capturing device associated with the digital screen checks for face detection and captures the image of the user in a controlled environment (210). Further the gender of the user is determined based on the gesture controls provided on the digital screen (215).

The captured image is then provided to a segmentation module in the image processing unit which segments the image of the user body from the background (220). For dividing the image into various segments, the segmentation module constructs a background model with mean and variance of successive frames. An initial foreground is constructed by the background difference, using multiple thresholds. Further the shadow regions are eliminated using the colour components and each object is labelled with a specific identification number.

The segmentation module then performs a contact point extraction on the objects. The morphological dilation is followed by the erosion and cleans up the anomalies in the target object. This morphological processing removes any small holes in the objects and smoothen any interlacing anomalies. The boundary of the objects is extracted from a subtraction between dilated image and eroded image. Further the control point tracking is carried out and during this step, the control points in the object are obtained by calculating the distance between the vertical axis and the boundary point of the image and considering the maximum distances on both sides (225).

The control points include but are not limited to the body points, the shoulder points and the head points. The control points determined are tracked and used to estimate the pose of the user (230). The 3D rendering engine then performs fitting and rendering the dress model on the user based on the pose information (235). The method further includes adjusting the apparel based on the control points detected for the user (240). Further, the apparel is fitted accurately on the user based on the physical statistics calculated and the 3D model of the apparel fitted on the user is rendered on the display unit of the digital screen (245).

The virtual apparel fitting system recognizes the physical statistics of an individual and enables the user to select the apparels of his/her preference virtually and displaying the appearance of the selected apparel on the user in a virtual mirror in real time. The system includes a digital screen and an image capturing device associated with the digital screen in a controlled environment. The system also includes an image processing unit integrated with the digital screen for image analysis of the user in real time.

When the user stands in front of the digital screen and the image of the user is captured by the image capturing device. The digital screen helps in the selection of the gender of the user by hand gesture as input. The digital screen includes a display unit which displays a 3D representation of a plurality of apparels to the user based on gender recognition. The system recognizes a plurality of physical statistics of the user for predicting the accurate size and analysis of fit of the apparel on the body of the user. The physical statistics includes a series of control points which are the reference points representing the body parts including shoulder and chest. The system further displays the user with the 3D model of the apparel fitted on the user on the digital screen without the user actually wearing them.

The image processing unit includes a segmentation module which performs an image processing by dividing the input image into various segments. The segmentation module initially constructs the background information from the image/video captured by the image capturing device. An initial foreground region is constructed by a background difference using multiple thresholds. The shadow regions are eliminated using the color components and each object is labeled with its own identification number. Further, the silhouette extraction techniques are used to smoothen the boundaries of the foreground region and region growing technique is employed to recover the required characteristics to generate the final foreground region. The foreground region thus identified is segmented from the background. Further the results are adjusted by concentrating on the face region and the body of the user is segmented out from the background.

The image processing unit further includes a 3D rendering engine which determines the control points of the segmented out image of the body of the user. The control points corresponding to face region, shoulder region and chest region are detected by an image analysis. Further the control points are refined to avoid any false detections contributing to the result. The control points are obtained by calculating the distance between the vertical axis from the nose tip point and the boundary point of the body and considering the maximum distances on both sides, the pose and the orientation of the user are further calculated using the control points by a tracking and pose estimation algorithm. The 3D rendering engine then performs a fitting and rendering of the dress model on the user based on pose.

The virtual apparel fitting performs the fitting and rendering of the 3D model of the apparel based on the pose of the user. The position and the orientation of the user are computed from the tracked control points using the pose estimation algorithm.

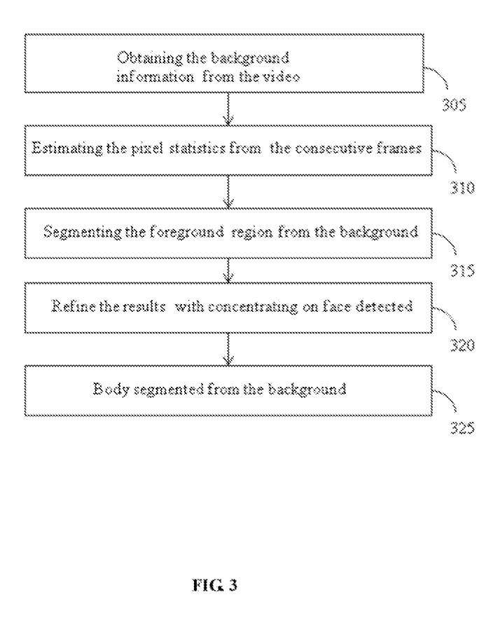

FIG. 3 illustrates a flowchart explaining a method for segmenting a user image from the background, according to an embodiment herein. With respect to FIG. 3, the method includes obtaining the background information from the video/image of the user standing in front of the digital screen (305). The pixel statistics of the information obtained are estimated from the consecutive frames (310). Further during segmentation process, the background model is constructed with the mean and variance of the successive frames. An initial foreground is constructed by a background difference, using multiple thresholds. The shadow regions are eliminated using the color components and each segment is labeled with its own identification number. The foreground region is segmented from the background after the segmentation process (315). Further the apparels are refined based on the face detection of the user in the image (320). The image of the body of the user is further segmented from the background (325).

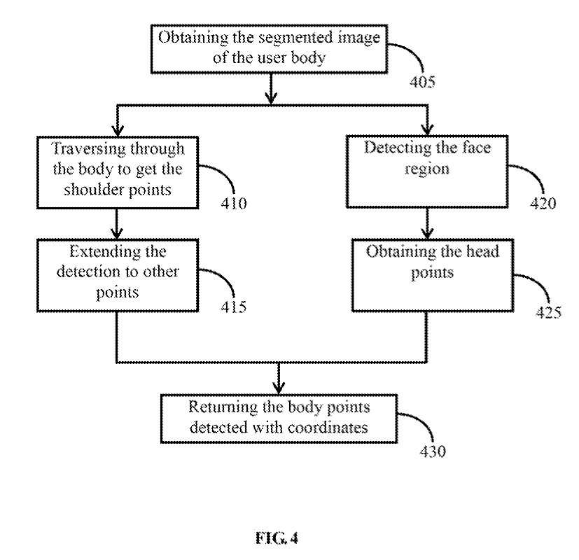

FIG. 4 illustrates a flowchart explaining a method for detecting the body point coordinates for fitting the apparel using a real time virtual apparel fitting system, according to an embodiment herein. With respect to FIG. 4, the method includes obtaining the body segments from the image captured (405). The segments include the foreground and the background of the image. The control points are determined for various body segments of the user. The method includes segmenting the image of the user body to determine, the face region (420). The image is segmented corresponding to the head region (425). The captured image is segmented to get a segmentation corresponding to shoulder part (410). The detection process is further extended to other points and the other regions in the captured image are then determined in accordance with the physical statistics obtained from the image. Further, the detected control points are pruned to avoid any false detection of the results and returns the body points detected with exact coordinates (430).

The various embodiments herein discloses a virtual apparel fitting system that captures an image or records the video of the user using a 2D camera in real time. The 2D camera used in the real time virtual apparel fitting system is comparatively less expensive to the 3D data scan devices. The real time virtual apparel fitting system proposed in the embodiments herein does not require any marker for marking the body point to adjust the apparel fitting on the user. The real time virtual apparel fitting system proposed in the embodiments herein requires minimal or no user interaction to display the apparels on the user in the virtual mirror. The virtual apparel fitting system proposed in the embodiments herein enables a user to quickly feel and experience the different kinds of the apparels virtually in less time and also enables a user to dress up virtually which in turn provides an efficient technique to showcase the apparels by without actually using them.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A virtual apparel fitting system comprising:
an image capturing device;
a digital screen;
Wherein the image capturing device captures an image of a user and the digital screen comprises an image processing unit and a display unit to recognize one or more physical statistics of a user and enables the user to select a plurality of apparels and displays the plurality of apparels virtually on the captured image of the user in the digital screen to predicting an accurate size and fit of a plurality of apparels on the user.

2. The virtual apparel fitting system of claim 1, wherein the image processing unit comprises a segmentation module and a 3D rendering engine.

3. The virtual apparel fitting system of claim 2, wherein the segmentation module is adapted to divide the captured image into a plurality of segments, detect a plurality of control points corresponding to physical statistics of the user from the plurality of segments and to segregate a foreground region from a background of the captured image of the user.

4. The virtual apparel fitting system of claim 1, wherein the 3D rendering engine optimizes the plurality of control points detected for an adjustment of an apparel on the user to provide an accurate fit.

5. The virtual apparel fitting system of claim 1, wherein the system calculates a pose and an orientation based on the plurality of control points generated, and wherein the generic 3D rendering engine uses these points to render an dressing model.

6. The virtual apparel fitting system of claim 1, wherein the position and orientation of the user optimized from the control points are computed using a pose estimation algorithm.

7. The virtual apparel fitting system of claim 1, wherein the digital screen helps in the selection of a gender of the user by using a hand gesture as an input.

8. The virtual apparel fitting system of claim 1, wherein the display unit displays a 3D representation of the plurality of apparels to the user based on an input gender information by the user using the hand gestures.

9. The virtual apparel fitting system of claim 1, wherein the image processing unit obtains a plurality of body co-ordinate measurements from the captured image of the user.

10. The virtual apparel fitting system of claim 1, wherein the physical statistics recognized are a plurality of reference points representing different body parts of the user.

11. A method for performing a virtual apparel fitting, the method comprises:
initiating a virtual apparel fitting application;
capturing an image of a user;
selection of a gender of the user by using a hand gesture as an input;
determining a foreground region and a background region in the captured image;
segregating the foreground region from the background region;
segmenting the foreground region of the captured image into one or more segments;
extracting a plurality of control points from each of the segment;
calculating a pose and an orientation of the user based on the extracted control points;
rendering a plurality of apparels virtually on the captured image;
optimizing the plurality of the control points to adjust the plurality of apparels virtually on the captured image; and
displaying a 3D representation of the plurality of apparels to the user with accurate fit.

12. The method for performing virtual apparel fitting of claim 11, wherein the plurality of apparels are selected from a virtual apparel library integrated with a digital screen.

13. The method for performing virtual apparel fitting of claim 11, wherein the segmenting of
the image comprises:
obtaining a background information from the captured image;
estimating a plurality of pixel statistics of the background information;
eliminating a plurality of shadow regions from the estimated plurality of pixel statistics; and
segmenting the image of the body of the user from the background information into a spatial information and a temporal information.

14. The method for performing virtual apparel fitting of claim 11, wherein optimizing the control points comprising the steps of:
obtaining one or more physical statistics recognized from the captured image of the user;
eliminating a false detection of the control points from the captured image;
calculating an accurate measurement of a size and a fit of the plurality of apparels on the user.
